(19) United States
(12) Patent Application Publication
(10) Pub. No.: US 2002/0107904 A1
(43) Pub. Date: Aug. 8, 2002

(54) Remote service agent for sending commands and receiving data over e-mail network

(76) Inventors: Kumar Talluri, Bridgewater, NJ (US); Ali Haddara, Piscataway, NJ (US)

Correspondence Address: OSTROLENK FABER GERB & SOFFEN, 1180 AVENUE OF THE AMERICAS, NEW YORK, NY, 100368403

(21) Appl. No.: 10/005,709

(22) Filed: Dec. 4, 2001

Related U.S. Application Data
(60) Provisional application No. 60/251,340, filed on Dec. 5, 2000.

(51) Int. Cl. G06F 15/16

(52) U.S. Cl. 709/202

(57) ABSTRACT

A communication system provides access to public and private data over a data network, wherein the private data is located behind firewalls. The communication system includes an e-mail box which is capable of receiving and storing all customer requests transmitted over the data network and coupled to a remote agent server which retrieves the stored requests. The remote agent server transmits the information obtained associated with the requests to the users. The system allows various communication devices to access public and private data bases on the existing communication infrastructure, including communication devices such as e-mail-enabled cell phones, PDA's, PC's, pages, etc. The system allows these communication devices to execute with simple comments from the communication device, native commands and applications on a remote host computer.

### CROSS REFERENCE TO RELATED APPLICATIONS

This application claims the benefit and priority of U.S. Provisional Application, Serial No. 60/251,340 filed Dec. 5, 2000 and fully incorporated herein by reference.

### FIELD OF THE INVENTION

The invention relates to a communication system that allows customer to easily access various types of corporate and public data securely through any electronic mobile communication device. Particularly, the invention relates to a communication system in which a service agent computer receiving customer commands from a user is capable of executing native host commands or applications in a remote host computer based on the customer commands.

### BACKGROUND OF THE INVENTION

The present invention provides a low cost, reliable solution to access public and private data over a data network, and furthermore, data behind corporate firewalls, securely from anywhere and at any time. Existing solutions are very expensive, proprietary and require expensive infrastructure and outside consulting support for systems integration.

### SUMMARY OF THE INVENTION

The present invention solves the above problem of providing low cost, reliable access to public and private data.

The present invention provides a remote service agent frame work that allows the execution of applications in a native host environment to access data resident inside a firewall or public data from the Internet or other data network. The invention uses the e-mail, SMS, ICQ, Instant Messenger (IM), etc., infrastructure to deliver remote commands. A server connected to the existing infrastructure executes the commands and delivers the requested data to the user.

Service requests can be sent by any e-mail, SMS, IM, etc., capable device, for example, from desktop e-mail, from a mobile phone, from a 2-way pager, from a PDA, etc.

According to the invention, a personalized environment is created based on the incoming e-mail or other address. This allows significant security and customization capabilities for each individual user or at the department or company level.

E-mail infrastructure is universally available. In the following, when e-mail infrastructure is referred to, it should be understood that other communication structures are also included, such as SMS, ICQ, and IM, without limitation. The invention uses the existing e-mail infrastructure as a transport mechanism and builds a solution on top of it. The present invention is designed with three main goals:

1. It provides an inexpensive frame work that allows data access at any time and from anywhere.

2. It allows services to be expanded (customizable) without any outside help (i.e., no need for expensive systems integration assistance).

3. It uses existing devices “as is” (or uses existing delivery infrastructure, i.e., PC's, wireless PDA's, e-mail enabled phones, http, SMS, WAP and Instant Messaging capable devices (AOL, MSM, Yahoo, ICQ), etc. to send commands and receive data.

The present invention thus uses the existing e-mail infrastructure to send requests and receive data.

The present invention is a remote service agent that is particularly useful with wireless devices. The present invention uses the e-mail transport protocol mechanism to enable devices such as cell phones, two-way pagers and PDA's to send the service requests and access both private and public data in a secure manner. Because the present invention uses the existing e-mail infrastructure, it requires no additional hardware or expensive proprietary software to function, thereby reducing the cost of remote data access dramatically.

The present invention is built on a frame work, which allows expansion of the system according to the user's personal or corporate requirements. New Services can be easily added and tagged as “public” or “private”. “Public” services are available to everyone. “Private” services can be personalized to each individual/department/corporation and are designed for the registered users including individuals, system administrators, software developers and techno hobbyists.

The present invention has the following features:

It allows access to data that resides inside of a corporate firewall.

It allows access to data from a personal or corporate calendar or telephone book.

It can retrieve corporate or personal e-mail while the user is on the road.

It allows remote execution of native host commands and applications.

There is no need for expensive hardware or specialized environments.

It works independently of existing information technology (IT) infrastructure, i.e., no need to disrupt or integrate with the existing systems, thus avoiding expensive integration costs.

It enables cell phones, two way pagers and PDA's with e-mail capability, to fetch both private and public data.

It extends the capabilities of pagers, PDA's and Blackberry devices with e-mail capabilities.

It acts as an agent to any wireless device with e-mail capability to perform tasks for the mobile users otherwise only possible if they are present at their desks.

It is customizable to individual requirements.

Other features and advantages of the present invention will become apparent from the following description of the invention which refers to the accompanying drawings.

### BRIEF DESCRIPTION OF THE DRAWINGS

FIG. 1A is an overall system diagram of the environment of the invention;

FIGS. 1B, 2A and 2B are flowcharts of the system of the invention; and

FIG. 3 is a block diagram of a service agent server in accordance with the invention.

### DETAILED DESCRIPTION OF EMBODIMENTS OF THE INVENTION

The present invention builds on the fact that e-mail is a simple and common way of communication. The user registers with an entity that provides the service of the present invention. The system provides a standard or base package and a customizable package. Users may choose to use the standard services provided with the base package to fetch information such as, for example, stock quotes, directions, restaurants, cinemas etc. or elect customization of the services.

The user sends a command via e-mail to a server device agent that has the software of the present invention loaded thereon requesting certain information or perform a task (see examples below). The agent processes the request to fetch the information, fetches the information by, e.g., linking to a source of the information and sends the information requested back via e-mail. It will send the information bails on the same channel through which the request came, i.e., e-mail, IM, SMS, ICQ, etc. The whole process takes a short time, e.g., less than a minute. If the request is a task, the task is executed and the status is sent back to the user.

Users may also add custom services that suit their own needs. For example, system administrators can develop new services (i.e., either perl scripts or shell commands) to monitor the status of key servers. They will be able to remotely send requests to find out the status or health of the servers within their business. The system can be configured so that only authorized employees can use the new services.

Individual users may install a version of the invention which works as a standalone server and runs on the user's home machine where the user has the liberty to install various personal services that can be invoked remotely.

Corporations may install another version of the invention which works in conjunction with the corporation's e-mail server and can handle a much larger number of requests and provide a different set of services and different levels of security for multiple departments.

According to the invention, certain free services may be provided. The system can be designed so that a user does not need to register to use these services. The user sends an e-mail from his two-way pager, or cell phone or desktop. For example, the user sends e-mail to “IΩinfowiz.com”, without any subject, and types “help” in the body of the e-mail message. The user will get back a list of services with examples:

To get help about the system:

“help” without any arguments will send back to the user a long document with many examples.

“help s” will send back to the user a shorter and concise version (about ½ page), which is particularly useful with mobile devices.

Other examples of free commands are follows:

To get stock quotes

q<symbol>+<symbol>+. . .

q intc+ibm+msft

To find a business address, telephone number etc.

find<city><state><keyword>[+aux_keyword>]

find somerset nj bookstore

find somerset nj cinema

find somerset nj pizza

find somerset nj pharmacy

find somerset nj computer+store

find somerset nj italian+restaurant

find somerset nj burger+king

find somerset nj taxi

find somerset nj church

Some other keywords that the user can use are:

catering, grocery, mc+donald, burger+king, flower+shop, library, taxi, rental+car, shopping+mall, university, police, congressman, senator, mayor, synagogue, temple and many more . . .

To find a person:

411<last>+<first>+<city>+<state>

411 clinton++washington+DC

411 clinton+bill++DC

411 clinton+bill+washington+DC

To find driving directions:

dir “from_street_addr” city state “dest_street_addr” city state

dir “100 Davidson Ave” Somerset N.J. “377 Hoes Lane” Piscataway N.J.

To query for system's host name (nslookup):

ns<hostname>

ns www.softdomain.com

To perform a health check of a machine:

ping<hostname>

ping www.infowiz.com

ping 192.168.1.100

To track shipments:

fedex <tracking number>

ups <tracking number>

airborne <tracking number>

For weather:

w<city state><zip code>

w piscataway+nj

w santaclara+ca

w 08854

Further services can be made available for registered users who want to access data residing on machines inside a firewall, e.g., from a personal workstation or corporate databases. Both individual level security control and service level control should be provided. Also, registered users can customize all the free services listed above.

An example is a customized stock quotes command. User X always checks for prices on his favorite 6 stocks. Instead of typing all the six symbols every time, User X can instead build a customer service called “myq” which will be translated to “q ibm+hp+intc+msft+beas+crus”. Uxer X can thus send the service request as:

myq

The user can also get a reminder. For example:

rem <month><day><reminder message>

rem 11 15 “bday card to sister”

A user may fetch mail from a mail server inside a firewall. If sent without any arguments, all the pending mail will be forwarded to a pre-configured e-mail address. The user can also specify receiving only the e-mails received from certain individuals:

fetchmail

fetchmail [<from1><from2>. . . <from N>]

fetchmail bil @microsoft.com

To get a document from the user 's personal work station: getdoc <file name>

getdoc mydata.doc

To convert a word/excel document and send the text back to the user:

doc2txt <filename>

xls2txt <filename>

doc2text mydata.doc

xls2txt salesdata.xls

To perform a system health check (for System Administrators):

sysstatus <host name>

systatus cosmos

To perform home control, mostly used with X-10 appliances):

homectl <device_numer|device_name><on|off>

homectl family_lamp on

homectl garage on

The general command format of the system of the invention is:

command [parameters] [>to_list] [<[EOF]

input data_line1

input_data_line2

. . .

input_data_linen

[EOF]

Various examples of command line arguments:

A) Execute the command specified by command name and return the result to the user device which sent the command if user is not a registered one.

Otherwise, send the result to the e-mail address in the user's environment. command [arg1 arg2. . . argN]

B) Execute the command but ignore the results i.e. don't send anything back.

Command [args]>

C) Execute the command and send copy of the results to each e-mail address after >sign. command>user1 @comapnyl.com . . .usrename@xyz.com

D) Execute the command by passing the data that follows as input. command [args]<EOF

input data line 1

input data line 2

. . .

input data line N

EOF

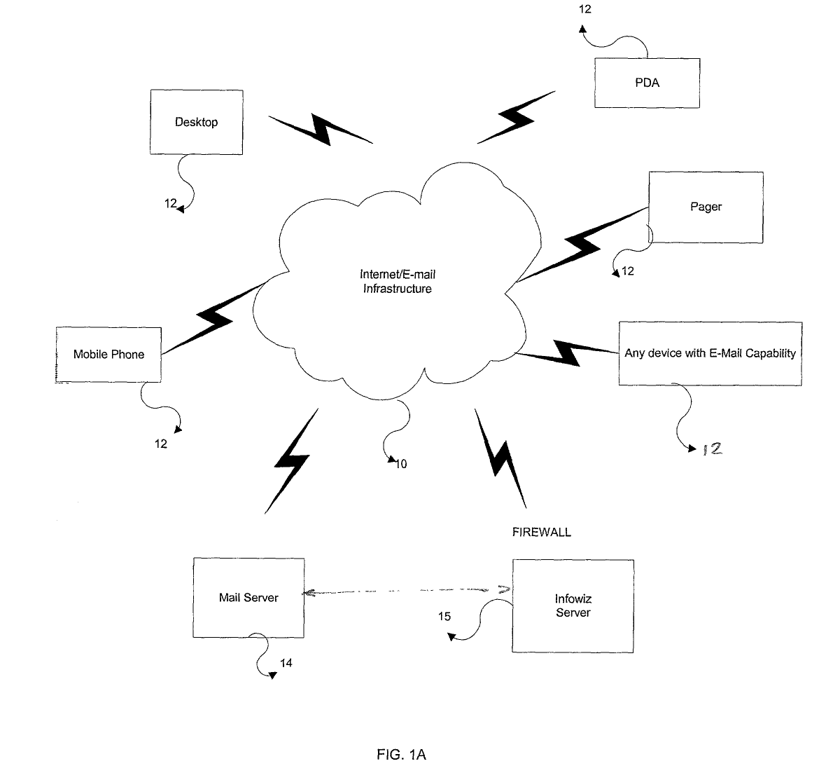

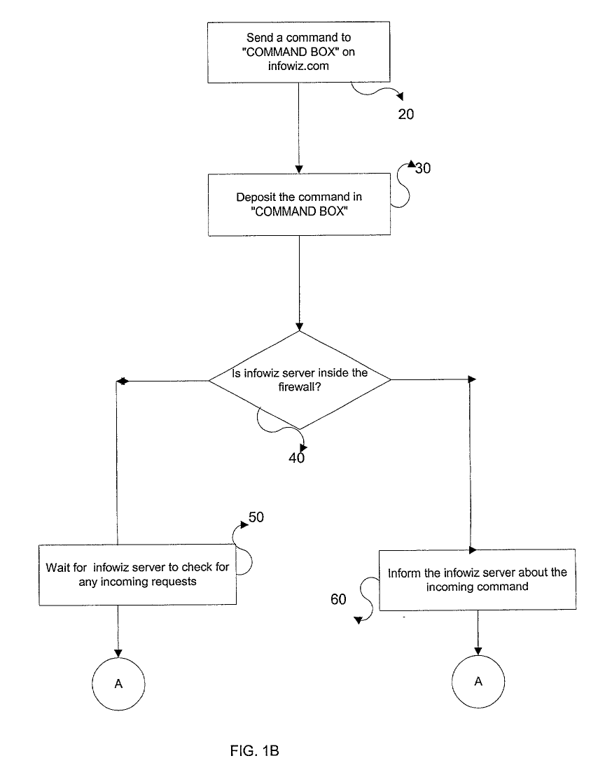

FIG. 1A is an overview of the system of the invention and its environment. The invention includes a server 15 (referred to sometimes as an infowiz server herein) server which is coupled to a digital network 10, for example, the Internet or other infrastructure for transmitting e-mail, SMS, ICQ, IM, etc. Various devices 12, for example, desktop computers, mobile phones, personal digital assistants (PDA's), pagers, etc. or any devices with e-mail capability are attached to the network 10. A mail server 14 is coupled to the network 10. The infowiz server 15 is coupled either inside a firewall, as shown, or outside a firewall, not shown. Any of devices 12 sends a command, for example, any of the commands listed as examples above, to a “COMMAND BOX” on the address for the server, in this case, identified as infowiz.com. This is identified by reference numeral 20 in FIG. 1B. The command is deposited in the COMMAND BOX of the mail server 14 as shown at 30. If the configuration is such that the mail server with the “COMMAND BOX” and infowiz server software are within the same network (i.e.: within the firewall), the mail server is pre-configured to hand over the in-coming request directly to the infowiz server, thus avoiding any delays.

However, if the mail server is outside the firewall and the InfoWIZ server is running inside the firewall, the InfoWIZ server periodically checks the COMMAND BOX for any incoming requests. Because the outside mail server that receives the commands cannot access the machines inside the firewalls, it is the responsibility of the InfoWIZ server 15 to probe the mail server for incoming requests. The probing interval is a user configurable parameter.

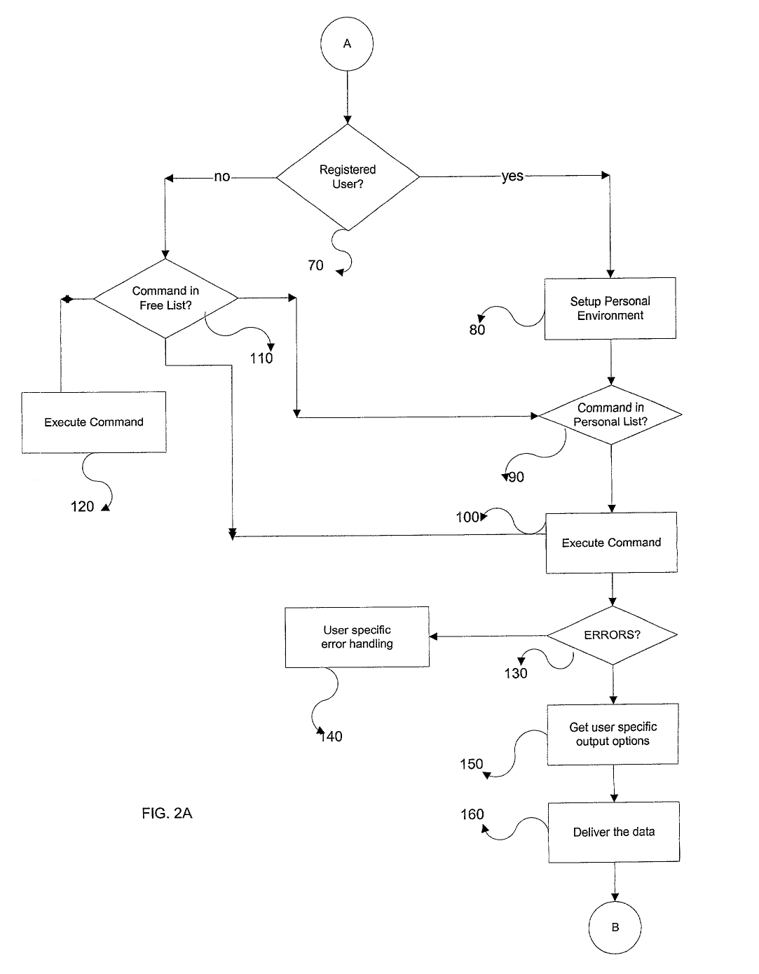

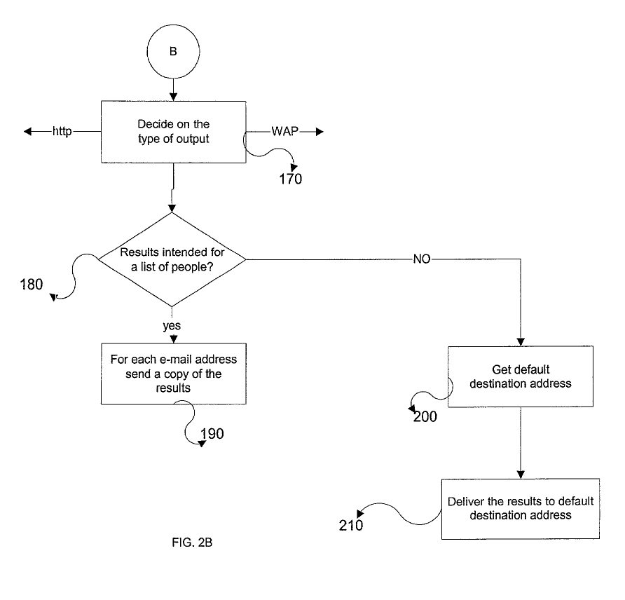

FIG. 2, comprising FIGS. 2A and 2B, shows the steps of operation of the server having the software of the invention resident thereon. The incoming request is read by the server and the server first determines whether the user is registered at 70. If yes, the user's personal environment is set up. A determination is then made at 90 if the command is in a personal list of the user. If yes, the command is executed at 100. If the command is not in the personal list, a determination is made as to whether the command is in public list as indicated at 110. If yes, the command is executed at 100. If the command is not in the public list and it is not in the personal list, the command is saved in a deleted list and the incoming request is removed from the queue as indicated at 120.

If the user is not registered as determined at step 70, a determination is made as to whether the command is in the public list. If it is in the public list, a command is executed at 100. If not, it is saved in the deleted list and the request is removed from the queue at 120.

Assuming a command is executed at 100, a check is then made to determine if there are any errors. If yes, user specific messages are sent at 140. If no errors have occurred, the system obtains user specific output options at 150 and then delivers the requested data in the user specified format as indicated at 160.

Turning to FIG. 2B, the data is delivered based upon the type of output, i.e., HTTP, WAP or e-mail. If a customer request is fetched by means of a device having instant messenger capabilities, such as AOL, MSN or Yahoo, the inventive system acts as a virtual user on the other end taking the customer request and executing it on the user's behalf in the native host environment and displays the output in the user's IM instantly. A determination is made, for e-mail, at 180, if the results are intended for a list of people. If yes, a copy of the results is sent to each e-mail address indicated at 190. It is not intended for a list of people, then the default destination address is obtained at 200 and the results are forwarded to the default address as indicated at 220.

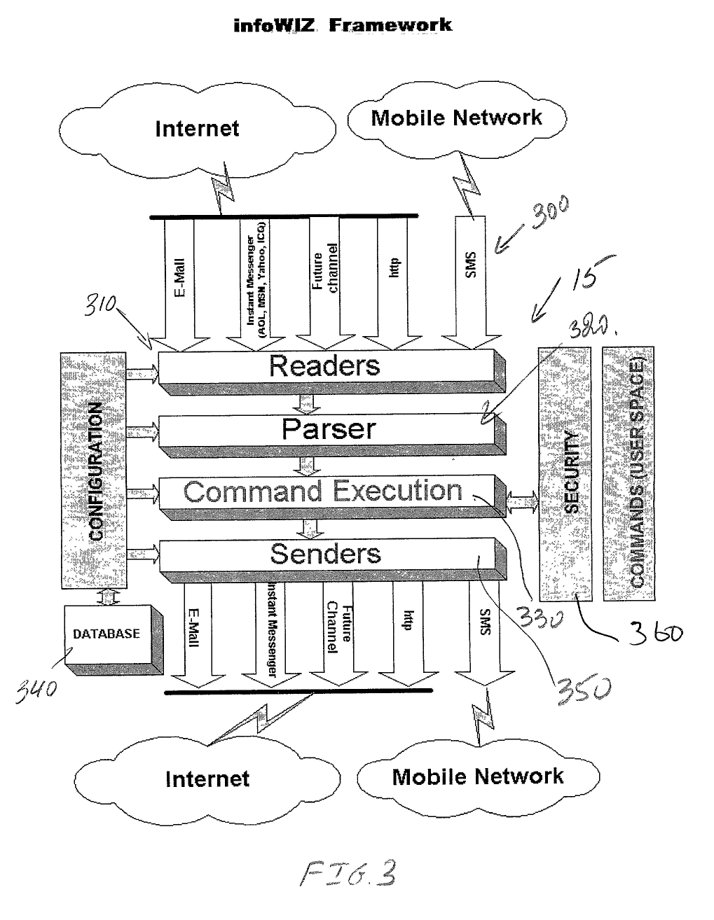

Turning to FIG. 3, the infowiz server 15 is presented in a somewhat more detailed view and provides a simple way to retrieve information using the existing e-mail infrastructure. The user merely types in a customer command using, for example, an e-mail, an instant messenger (AOL, MSM, Yahoo, ICQ, etc), http or SMS as shown at 300. The server 15 having software executing thereon is capable of reading the customer command at 310 with subsequent parsing thereof at 320. The server 15 further has software for executing the customer command at 330 and at least one database 340. The database accessible by the server 15 stores a customized list of customer commands, a list of remote host computers, as well as public and private lists of services performed by the server 15. The server executes native host commands or applications in the remote host computers based on a customer command and sends data back to the user at 350 using the same channel of communication as the user originally used.

Thus, the present invention provides a simple way to retrieve information using existing e-mail infrastructure. The user types in a command request, as shown in the examples above, and the server, having software from the present invention resident thereon, will obtain the required information from sources coupled to the digital data network. The user can fetch mail from a mail server inside a corporate firewall as shown above or other private information behind a firewall, or publicly accessible information. The present invention thus provides a simplified, cost-effective way to obtain information reliably and simply with any e-mail equipped device. The e-mail equipped device, with the appropriate command, accesses the server over the existing e-mail infrastructure which server then obtains the requested information and forwards it back to the e-mail equipped device over the existing e-mail infrastructure.

Although the present invention has been described in relation to particular embodiments thereof, many other variations and modifications and other uses will become apparent to those skilled in the art. Therefore, the present invention should be limited not by the specific disclosure herein, but only by the appended claims.

What is claimed is:

1. A method of executing at least one native host command or application in a remote host computer over a communication link via a communication device, the method comprising:
providing a service agent computer having an interface coupled to the network to which a user has access via the communication device for receiving a customer command;
receiving the customer command at the service agent computer;
executing by the service agent computer at least one native host command or application based on the customer command in the remote host computer; and
transmitting data associated with the customer command from the remote host computer to the communication device via the network.

2. The method as recited in claim 1 wherein the communication device of the customer comprising at least one of a PC, wireless PDA, e-mail enabled phone, SMS, WAP and Instant Messaging device, including AOL, MSM, Yahoo, ICQ, and any combination of these.

3. The method as recited in claim 1, wherein the interface of the service agent computer is coupled to the network directly.

4. The method as recited in claim 1, wherein the interface of the service agent computer is a secure interface coupled to the network via a firewall.

5. The method as recited in claim 1, further comprising the step of providing an e-mail box computer having a respective interface which is coupled to the communication device of the user via the network for receiving the customer command and further coupled to the service agent computer.

6. The method as recited in claim 5, further comprising the step of automatically handing over a stored customer command from the e-mail box computer to the service agent computer, thereby avoiding any delays during transmission of the customer requests via the network.

7. The method as recited in claim 5, further comprising the step of periodically probing the e-mail box computer by the service agent computer, the interface of the service agent computer being coupled to the network via a firewall.

8. The method as recited in claim 7, wherein an interval of probing is a user configurable parameter.

9. The method as recited in claim 6, wherein the e-mail box and service agent computers are located within the same firewall.

10. The method as recited in claim 1, wherein the customer command comprises at least one of a request for delivering stock quotes, locating business and home addresses and telephone numbers of businesses and persons, providing driving directions, performing a health check of a machine, tracking shipments and updating weather reports, and a combination of these.

11. The method as recited in claim 1, wherein the customer command can be expanded, the method further comprising the steps of preparing a short or long list of services performed by the service agent computer and e-mailing the list to the user.

12. The method as recited in claim 10, further comprising the step of registering users.

13. The method as recited in claim 10, further comprising the step of allowing execution of a customer command seeking confidential data from the remote host computer after verifying that the user is registered, the remote host computer containing the confidential data being associated with personal workstations or with a corporate database which is located inside a firewall.

14. The method as recited in claim 13, further comprising the step of selectively fetching and sending e-mail stored on the personal workstation to a pre-configured e-mail address of the registered users.

15. The method as recited in claim 12, further comprising the steps of allowing the registered users to customize the customer command and of storing the customized customer command as a non-public list on the service agent computer.

16. The method as recited in claim 1, further comprising the step of storing a public list of publicly available services, whereby the service agent computer processes the customer command as to publicly available data regardless of whether the user is registered.

17. The method as recited in claim 16, further comprising the steps of determining whether the user is registered, determining whether the customer command seeks publicly available data, and determining whether the registered user has a non-public list stored on the service agent computer.

18. The method as recited in claim 17, further comprising the step of saving the customer command of the registered user requesting data which is neither on the public list nor on the non-public list.

19. The method as recited in claim 1, further comprising the step of verifying the correctness of data received from the host computer before transmitting the received information to the user.

20. The method as recited in claim 1, further comprising the step of determining the communication channel of the communication device and transmitting information associated with the customer command to the user, the step of determining comprising determining of the communication channel is one of an HTTP, WAP, e-mail, an IM environment.

21. The method as recited in claim 20, further comprising the step of determining whether the user requesting execution of the customer command is associated with a multiplicity of users having different e-mail addresses which are stored on the service agent computer, the different e-mail addresses being stored as a pre-configured e-mail list, and transmitting a copy of the received information to each e-mail address on the list .

22. A system for allowing a user having a communication device to execute at least one native host command or application on a remote host computer over a communication link, the system comprising:
a service agent computer having an interface coupled to the network, the service agent computer being configured so as to:
receive a customer command from the communication device on the network;
based on the received customer command execute a native host command or application on the remote host computer; and
transmit data associated with the customer command to the user via the network.

23. The system as recited in claim 22, further comprising a e-mail box computer having an interface coupled to the network and to the service agent computer, the e-mail box computer being configured so as to perform an operation comprising at least one of:
directly receiving the customer command,
storing the customer command,
handing over the customer command to the remote host computer, and a combination thereof.

24. The system as recited in claim 23, wherein the service agent and e-mail box computers are directly coupled to the network, the e-mail box computer handing over the received information to the service agent computer without substantial delay.

25. The system as recited in claim 23, wherein the service agent and e-mail box computers are located behind the same firewall.

26. The system as recited in claim 22, wherein the service agent computer is located behind a firewall, the service agent computer probing the e-mail box computer located outside of the firewall to retrieve the stored customer command.

27. The system as recited in claim 26, wherein the service agent computer probes the e-mail box computer at periodic intervals, the service agent computer having software executing thereon for allowing the user to select an interval of probing.

28. The system as recited in claim 26, wherein the service agent computer has software executing therein for allowing the user to create a customized list of consumer commands or applications, the system further comprising a customization database coupled to the service agent computer and storing the customized list of consumer commands.

29. The system as recited in claim 22, wherein the service agent computer has software executing thereon for at least one of obtaining data related to stock quotes, locating business and home addresses and telephone numbers of businesses and persons, providing driving directions, performing a health check of a machine, tracking shipments and updating weather reports, and a combination of these.

30. The system as recited in claim 22, wherein the communication device has an e-mail capability and is selected from a two-way pager, PDA, cell-phones, PC, laptop and a combination thereof.

31. The system as recited in claim 22, wherein the network is the Internet.

32. The system as recited in claim 22, wherein the service agent computer has software executing thereon for registering users, the system further comprising a user database storing a list of registered users and accessible by the service agent computer.

33. The system as recited in claim 32, wherein the service agent computer has software executing thereon for identifying the registered users and software for identifying at least one stored customized list of customer commands associated with the identified registered user.

34. The system as recited in claim 22, wherein the system further comprises a user list database storing a customizable list of users and accessible by the service agent computer upon receiving data from the remote host computer.

35. The system as recited in claim 34, wherein the service agent computer has software executing thereon for providing a copy of the received data to each of the users the stored customized list of users, and software executing on the service agent computer for using an e-mail transport protocol to send a respective copy to each e-mail address on the stored customized list of users.

36. The system as recited in claim 22, wherein the service agent computer allows the customer command to be transmitted behind a firewall protecting the remote host computer.

37. The system as recited in claim 22, wherein the service agent computer software executing thereon for checking the functionality of a user server coupled to the network, retrieving an e-mail stored on a private workstation associated with the registered user, and a combination thereof in response to the customer command.

38. The system as recited in claim 37, wherein the service agent computer has software executing thereon for sequentially checking whether the customer command has been sent from a registered user or a non-registered user, the customer command is on a private list or public list of information, and software for storing the customer command which is neither on the private list nor on the public list if the user filing the customer command is registered.

39. The system as recited in claim 38, wherein the service agent computer has software executing thereon for verifying data obtained form the remote host computer.

40. The system as recited in claim 39, wherein the service agent computer allows the obtained information to be delivered based on a type of communication channel employed by the user and comprising one of HTTP, WAP, e-mail, IM and SMS.

41. The system as recited in claim 23, wherein the communication device comprises one of a cell phone, PDA, pager, PC, Palm and Blackberry device.
